(19) United States
(12) Patent Application Publication
(10) Pub. No.: US 2008/0020740 A1
(43) Pub. Date: Jan. 24, 2008

(54) Mobile Telephone Unit, Method for Outputing Alarm of Mobile Telephone Unit, and Program Therefor

(75) Inventors: Miwa Koshijima, Osaka-shi (JP); Yuuichi Taneya, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 10/590,015

(22) PCT Filed: Feb. 25, 2005
(86) PCT No.: PCT/JP05/03202

§ 371 Date: Aug. 21, 2006

(30) Foreign Application Priority Data
Feb. 26, 2004 (JP) 2004-051290

(51) Int. Cl. H04M 3/42

(52) U.S. Cl. 455/414.2

(57) ABSTRACT

To provide a mobile phone that can achieve an alarm function by receiving broadcasts such as radio broadcasts when possible, assuming a case where a reception level of a broadcast signal of a set broadcast station is low. At a predetermined time, a mobile phone (101) having a function for receiving broadcasts as an alarm starts receiving a broadcast from a set broadcast station (104). When a receiving sensitivity of the set broadcast station (104) is weak, the mobile phone (101) acquires a self-position of using a GPS etc., reads a zone correspondence broadcast station table (300) stored in the mobile phone (101), receives a broadcast from another broadcast station (105) in a zone corresponding to the self-position, and outputs a broadcast having a stronger receiving sensitivity instead of the broadcast from the set broadcast station (104), thereby achieving an alarm function.

### TECHNICAL FIELD

The present invention relates to a mobile phone having a broadcast receiving function and an alarm function.

### BACKGROUND ART

In recent years, mobile phones having not only communication functions but also many additional functions have spread. Such additional functions include a broadcast receiving function of radios and televisions, a self-position searching function using a GPS (Global Positioning System), and the like, in addition to a conventionally equipped alarm function.

Alarm functions are used as an alarm clock. A user carries a mobile phone on a pleasure or business trip, and uses its alarm function as an alarm clock during the trip.

However, as built-in alarm sounds are annoying to some users, mobile phones are often used with its alarm function being stopped.

Therefore, such alarm function does not sufficiently realize its value as an additional function at present.

Radio receivers are widely used as an alarm device. Japanese Patent Application Publication No. H5-22172 discloses an art relating to a radio receiver having an alarm function. In this art, a radio broadcast is played from a speaker at a set time. When the radio broadcast cannot be received, a built-in alarm sound is played instead of the broadcast. This art is applicable to mobile phones.

### DISCLOSURE OF THE INVENTION

The Problems the Invention is going to Solve

However, as an alarm function of a mobile phone is often used on a pleasure or business trip, a set frequency range is different from a frequency range of an area where the mobile phone is used during the trip in many cases. As a result, as a radio broadcast cannot be received, an undesired built-in alarm sound is played instead.

In the light of the above problems, the present invention aims to provide a mobile phone that can preferably play a broadcast without playing an undesired alarm sound, even during a pleasure or business trip.

In order to solve the above problem, the present invention is a mobile communication terminal having an alarm function, including: a receiving unit operable to receive a broadcast; a position information acquisition unit operable to acquire position information of the mobile communication terminal; a storage unit operable to store a plurality of pieces of broadcast station information that correspond to zones; a determination unit operable to determine a zone to which the position information belongs; a detection unit operable to detect a receiving intensity of the broadcast received by the receiving unit; a control unit operable to (a) cause the receiving unit to start receiving a preset broadcast, (b) cause the position information acquisition unit, when a receiving intensity of the preset broadcast detected by the detection unit is less than a prescribed value, to newly acquire position information, (c) read a piece of the broadcast station information that corresponds to a zone determined by the determination unit based on the newly acquired position information, (d) cause the receiving unit to receive a broadcast identified by the piece of the broadcast station information, and (e) select a broadcast having a receiving intensity of no less than the prescribed value; and an output unit operable to output the selected broadcast at an alarm set time.

With the above structure, when an electric field intensity of a receiving electric wave of a radio broadcast or a television broadcast set to be received at an alarm set time is less than a prescribed value, the mobile phone according to the present invention selects a broadcast of a receiving electric wave having an electric field intensity of no less than the prescribed value by scanning frequencies. Thereby, the mobile phone can achieve an alarm function by playing the broadcast or displaying an image on a screen thereof.

Also, the control unit may cause the receiving unit to receive the broadcast having a highest receiving intensity detected by the detection unit among the broadcasts identified by the piece of the broadcast station information.

Accordingly, the mobile phone receives a broadcast of a receiving electric wave having a highest electric field intensity. Thereby, the mobile phone can play the broadcast clearly.

Also, the position information acquisition unit may acquire the position information of the mobile communication terminal using a GPS.

Accordingly, the mobile phone can acquire longitude and latitude information thereof. When a set broadcast cannot be received, the mobile phone can determine a zone for selecting a broadcast different from the set broadcast.

Also, the position information acquisition unit may acquire position information of a base station by communicating with the base station, and defines the position information as the position information of the mobile communication terminal.

Accordingly, the mobile phone recognizes a position of a base station near a position of the mobile phone, detects a zone to which the base station belongs, and regards the zone as a zone to which the mobile phone belongs, thereby reading broadcast station information.

Also, the broadcast station information may correspond to one or more zones.

Accordingly, even when the alarm function of the mobile phone is used in a zone different from a usual zone, a broadcast to which the user often listens can be played as the broadcast corresponds to the both zones.

Also, the detection unit may detect an electric field intensity of a receiving electric wave of the broadcast received by the receiving unit, and the prescribed value may be a value of an electric field intensity indicates that the broadcast is clearly receivable.

Accordingly, a receiving electric wave of a broadcast to be selected surely has a sufficient electric field intensity. Thereby, a practical alarm function can be realized.

Also, the control unit, when the broadcast having the receiving intensity of no less than the prescribed value is not found, may cause the output unit to output a built-in alarm sound.

Accordingly, when a broadcast of electric wave having an electric field intensity of no less than the prescribed value is not found in all broadcast areas, the mobile phone plays the built-in alarm sound. Thereby, a needed alarm function can be guaranteed.

Also, the control unit, to cause the output unit to output the broadcast at the alarm set time, may start the detection unit before a time period sufficient for selecting the broadcast having the receiving intensity of no less than the prescribed value.

Accordingly, the mobile phone can play the broadcast exactly at the alarm set time.

### BRIEF DESCRIPTION OF THE DRAWINGS

FIG. 1 is a schematic diagram showing a structure of a system including a mobile phone according to an embodiment of the present invention;

FIG. 2 is a functional block diagram showing the mobile phone according to the present invention;

FIG. 3 shows a zone correspondence broadcast station information table stored in a storage unit of the mobile phone according to the present invention;

FIG. 4 is a front view showing the mobile phone according to the present invention;

FIG. 5 shows a method for determining a zone to which a position of the mobile phone belongs in a control unit of the mobile phone according to the present invention;

FIG. 6 is a flowchart (1) showing operations of the mobile phone according to the present invention; and

FIG. 7 is a flowchart (2) showing operations of the mobile phone according to the present invention.

### BEST MODE FOR CARRYING OUT THE INVENTION

The following will describe an embodiment of a mobile phone according to the present invention with reference to the drawings.

### EMBODIMENT

<Structure>

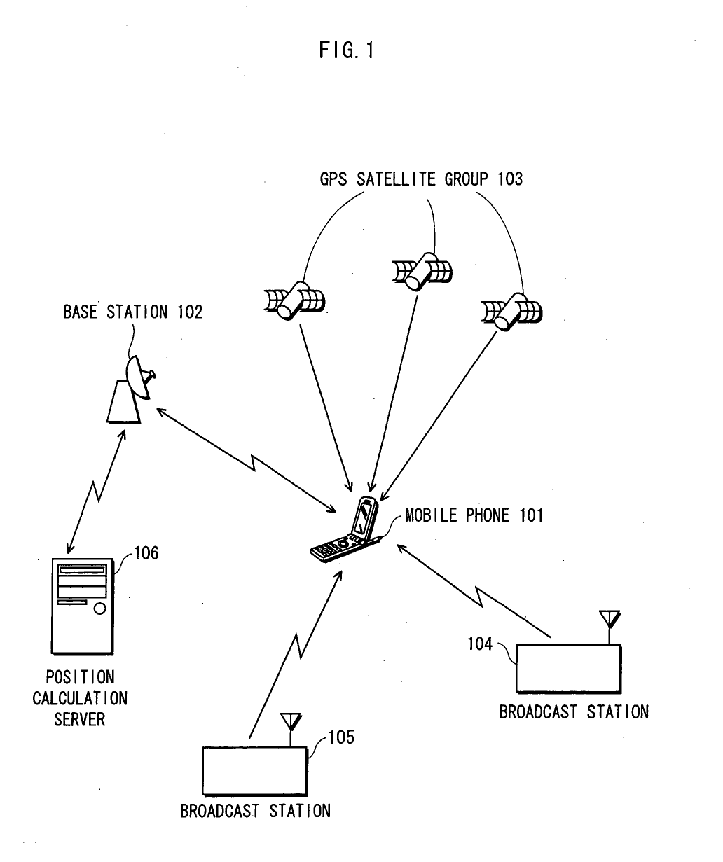

FIG. 1 is a schematic diagram showing a system including a mobile phone according to the present invention.

This system includes a mobile phone 101, a base station 102, a GPS satellite group 103, a broadcast station 104,.another broadcast station 105, and a position calculation server 106.

The broadcast station 104 is a broadcast station that provides a broadcast received by the mobile phone 101 at an alarm set time. The broadcast station 105 is a broadcast station.

The mobile phone 101 receives an electric wave from the GPS satellite group 103, and the position calculation server 106 receives data relating to position information from the mobile phone 101 via the base station 102, and calculates a longitude and a latitude of a position of the mobile phone 101.

The position calculation server 106 transmits information of the calculated longitude and latitude to the mobile phone 101 via the base station 102.

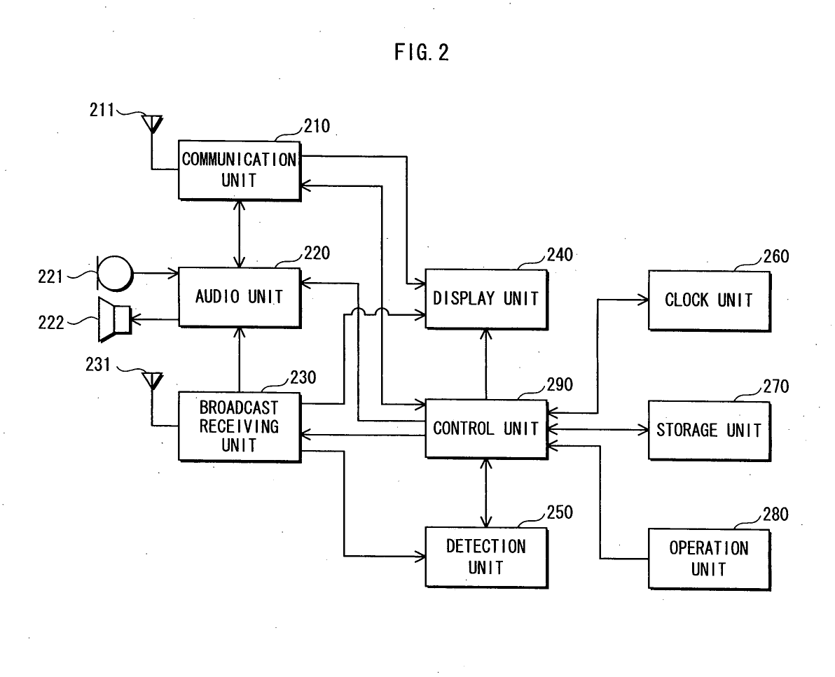

FIG. 2 is a functional block diagram showing the mobile phone 101.

As shown in FIG. 2, the mobile phone 101 is composed of a communication unit 210, an antenna 211, an audio unit 220, a microphone 221, a speaker 222, a broadcast receiving unit 230, an antenna 231, a display unit 240, a detection unit 250, a clock unit 260, a storage unit 270, an operation unit 280, and a control unit 290.

The communication unit 210 demodulates a receiving signal outputted from the antenna 211 into a reception audio signal and a receiving data signal, outputs the demodulated reception audio signal to the audio unit 220, and outputs the demodulated receiving data signal to the display unit 240 and the control unit 290. Also, the communication unit 210 modulates a transmission audio signal A/D converted by the audio unit 220 and a transmission data signal such as an electronic mail outputted from the control unit 290, and outputs the modulated signals outside via the antenna 211. Furthermore, the communication unit 210 acquires a signal for requesting position information from the control unit 290, and transmits an electric wave reception request to the GPS satellite group 130. And then, the communication unit 210 transmits data of a time period until an electric wave reaches the mobile phone 101 from each satellite, to the position calculation server 106 via the base station 102. The communication unit 210 outputs longitude and latitude information transmitted from the position calculation server 106, to the control unit 290.

The audio unit 220 D/A converts the reception audio signal outputted from the communication unit 210, and outputs the D/A converted reception audio signal to the speaker 222. Also, the audio unit 220 A/D converts the transmission audio signal acquired from the microphone 221, and outputs the A/D converted transmission audio signal to the communication unit 210.

A general conventionally used structure is suitably employed for realizing a structure of a GPS and transmission and reception of audio and data. Therefore, the description will be omitted here.

The broadcast receiving unit 230 demodulates a radio broadcast signal acquired from the antenna 231 into an audio signal, and outputs the demodulated audio signal to the audio unit 220. Also, the broadcast receiving unit 230 outputs the radio broadcast signal to the detection unit 250. Note that the antenna 231 may be shared with the antenna 211. Furthermore, the broadcast receiving unit 230 receives a broadcast of a broadcast station specified by the control unit 290.

The display unit 240 is realized with a liquid crystal display and the like, and displays an electronic mail acquired from the communication unit 210 and a standby screen, and the like.

The detection unit 250 detects an electric field intensity of the radio broadcast signal acquired from the broadcast receiving unit 230, and outputs the detected electric field intensity to the control unit 290.

The clock unit 260 clocks a current time, and outputs the current time in accordance with a time acquisition request by the control unit 290.

The storage unit 270 includes a ROM (Read Only Memory) and a RAM (Random Access Memory). The ROM specifically holds a zone correspondence broadcast station information table, a prescribed value of electric field intensity for judging a level of an electric field. intensity, and a program for receiving a broadcast using an alarm function. The RAM holds an alarm set time set by the user and broadcast station information relating to a broadcast to be played instead of an alarm sound.

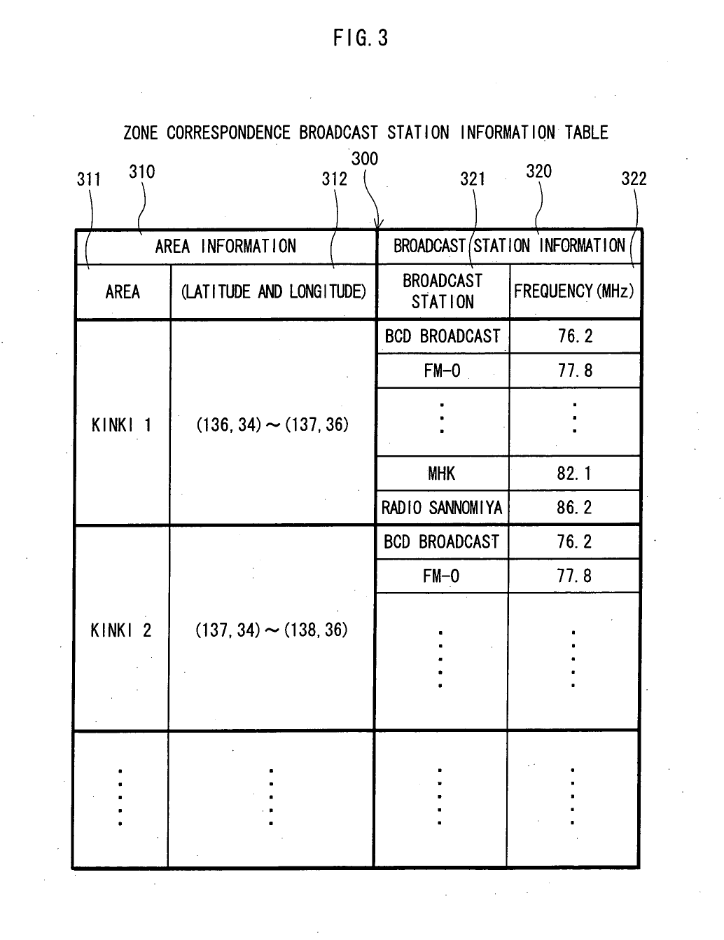

FIG. 3 shows an example of the above-mentioned zone correspondence broadcast station information table. A zone correspondence broadcast station information table 300 includes a zone information field 310 and a broadcast station information field 320. Furthermore, the zone information field 310 includes a zone field 311 and a longitude and latitude information field 312. The broadcast station information field 320 includes a broadcast station field 321 and a frequency field 322 corresponding to each broadcast station. In the zone field 311, names for recognizing each zone are written for convenience. In this example, “Kinki 1”, “Kinki 2”, and the like are written. In the longitude and latitude information field 312, longitude value and latitude values of two location points that defines a range of each zone written in the zone field 311. A method for determining an area based on longitude and latitude values of two location points will be described later. In the broadcast station field 321, a name of a broadcast station receivable in each zone is written. In the frequency field 322, a value of a frequency of each broadcast station written in the broadcast station field 321.

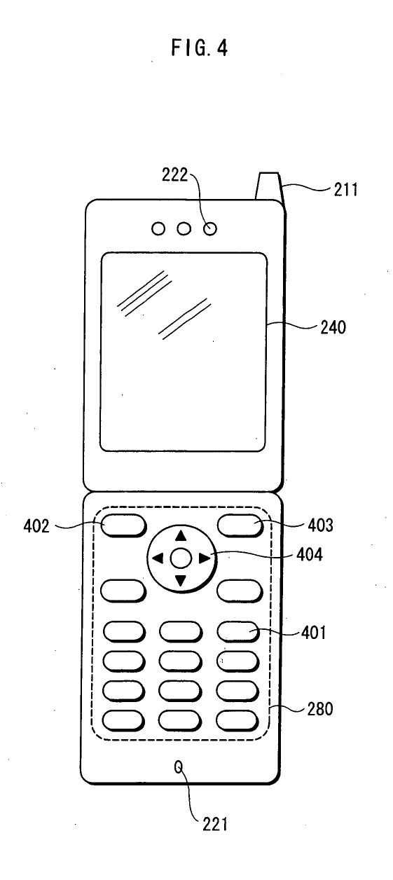

FIG. 4 shows an arrangement of keys included in the operation unit 280 of the mobile phone 101.

The operation unit 280 includes a ten keypad 401, an on-hook key 402, an off-hook key 403, and a cursor key 404, which are used for dial operations, call start operations, call end operations, operations of setting an alarm function, and the like.

The control unit 290 controls each unit of the mobile phone 101, and has a hardware structure including a CPU (Central Processing Unit). The control unit 290 reads a program for receiving a radio broadcast as an alarm from the storage unit 270, and executes the read program. The control unit 290 performs the following in accordance with the program.

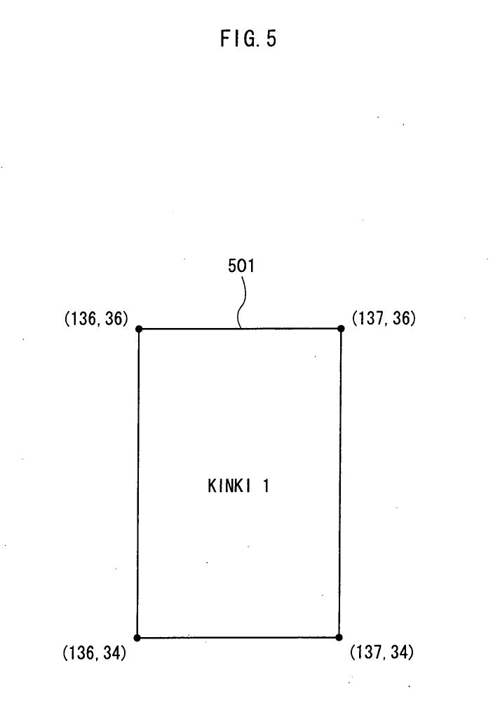

In accordance with an instruction outputted from the operation unit 280, the control unit 290 stores an alarm set time, a set receiving broadcast station, and the like, in the RAM of the storage unit 270. Also, the control unit 290 acquires a current time from the clock unit 260 simultaneously with reading the alarm set time from the storage unit 270. The control unit 290 compares the current time with the alarm set time. When these times matches each other, the control unit 290 has the broadcast receiving unit 230 start receiving a broadcast of the set receiving broadcast station. Furthermore, the control unit 290 has the detection unit 250 detect an electric field intensity of a broadcast signal outputted from the broadcast receiving unit 230 to the detection unit 250. The control unit 290 compares the electric field intensity acquired from the detection unit 250 with the prescribed value of electric field intensity acquired from the storage unit 270. When the electric field intensity is no less than the prescribed value of electric field intensity, the control unit 290 has the audio unit 220 output the broadcast as audio from the speaker 222. When the electric field intensity is less than the prescribed value of electric field intensity, the control unit 290 acquires the longitude and latitude information of the mobile phone 101 acquired using the GPS, from the communication unit 210. Based on the acquired latitude and longitude information, the control unit 290 determines a zone to which the mobile phone 101 belongs, among the zones written in the zone correspondence broadcast station information table 300. FIG. 5 shows a method for determining a zone to which the mobile phone 101 belongs.

In this method, a range of a zone is determined, for example, by dividing all areas of Japan into a plurality of zones. FIG. 5 shows a Kinki 1 zone 501 written in the zone correspondence broadcast station information table 300, as an example. The Kinki 1 zone 501 is defined by two location points: a point (136, 34) and a point (137, 36). In this case, the point (136, 34) indicates a point of 136 degrees east longitude and 34 degrees north latitude. A zone defined by two location points such as the Kinki 1 zone 501 is within a range defined by four location points of (136, 34), (137, 34), (137, 36), and (136, 36). That is, a zone defined by two location points of Point A (x1, y1) and Point B (x2, y2) is generally a zone defined by line segments of AC, BC, AD, and BD. The line segments are defined by four location points of Point C (x2, y1) and Point D (x1, y2), in addition to Point A and Point B. The control unit 290 determines that Point E belongs to the zone, when Point E (x3, y3) satisfies all the following four formulas: x1-x3<0; x2-x3≧0; y1-y3<0; and y2-y3≧0.

Furthermore, the control unit 290 has the broadcast receiving unit 230 receive a frequency of a broadcast station written in the broadcast station field 321 corresponding to a determined zone, in an ascending order by switching frequencies, until finding a broadcast of a broadcast signal having an electric field intensity of no less than the prescribed value of electric field intensity. When the broadcast of the broadcast signal having the electric field intensity of no less than the prescribed value of electric field intensity is found, the control unit 290 has the audio unit 220 output the broadcast as audio from the speaker 222. When the broadcast of the broadcast signal having the electric field intensity of no less than the prescribed value of electric field intensity is not found, the control unit 290 reads a built-in alarm sound stored in the storage unit 270, and has the audio unit 220 output the read built-in alarm sound as audio from the speaker 222.

<Operations>

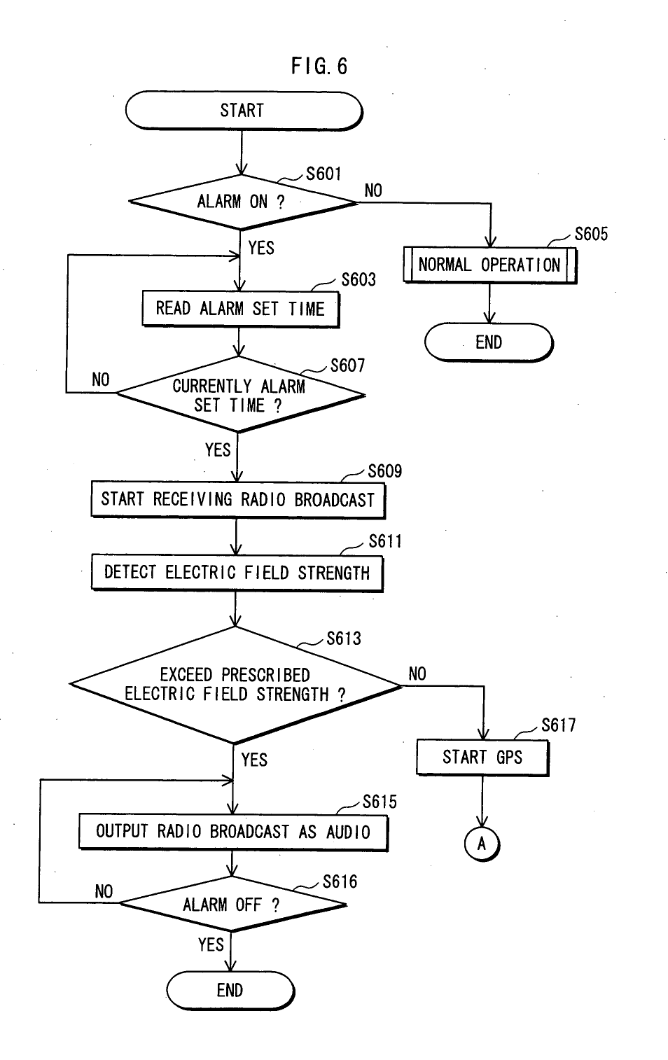

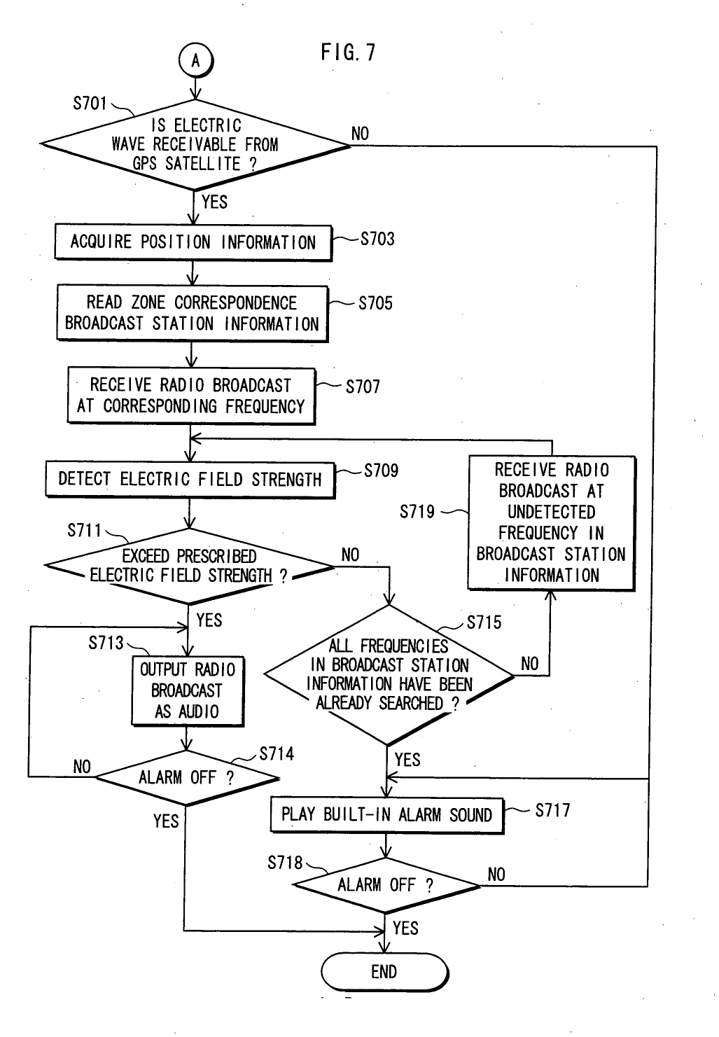

Next, the operations in the embodiment will be described with reference to the flowcharts shown in FIGS. 6 and 7.

In the mobile phone 101, the control unit 290 confirms whether an alarm set by the user held in the RAM of the storage unit 270 is ON (Step S601). When the alarm is OFF, the mobile phone 101 continues normal operations (Step S605).

When the alarm is ON, the control unit 290 reads an alarm set time from the storage unit 270 (Step S603). When a time outputted from the clock unit 260 matches the alarm set time (Step S607), the control unit 290 has the broadcast receiving unit 230 start receiving a broadcast from a broadcast station at a frequency set as the alarm (Step S609).

The broadcast receiving unit 230 outputs a receiving electric wave of the broadcast to the detection unit 250, and the detection unit 250 detects an electric field intensity of the receiving electric wave (Step S611).

The control unit 290 receives the electric field intensity from the detection unit 250 simultaneously with reading a prescribed value of electric field intensity stored in the storage unit 270, and compares the two values (Step S613). When the electric field intensity is no less than the prescribed value of electric field intensity, the broadcast receiving unit 230 outputs the broadcast to the audio unit 220. The audio unit 220 outputs the broadcast as audio from the speaker 222 (Step S615). When receiving an operation from the operation unit 280, the control unit 290 stops outputting the broadcast, and ends the processing (Step S616).

When the electric field intensity is less than the prescribed value of electric field intensity, the control unit 290 has the communication unit 210 acquire a position of the portable phone 101 using the GPS (Step S617).

The communication unit 210 judges whether an electric wave can be received from a predetermined number of satellites of the GPS satellite group 103, for example, no less than three GPS satellites (Step S701). When the electric wave cannot be received, the control unit 290 has the audio unit 220 output the built-in alarm sound held in the storage unit 270 from the speaker 222, instead of the broadcast (Step S717).

When the electric wave can be received, the control unit 290 receives longitude and latitude information from the communication unit 210 (Step S703) simultaneously with reading the zone correspondence broadcast station information table 300 shown in FIG. 4 from the storage unit 270 (Step S705). The control unit 290 determines to which zone the received longitude and latitude information belongs, based on the method shown in FIG. 5, and selects broadcast station information corresponding to a zone to which the received longitude and latitude information belongs. The control unit 290 has the broadcast receiving unit 230 receive a broadcast from a broadcast station in the selected broadcast station information in an ascending order of frequencies (Step S707). The detection unit 250 detects an electric field intensity of each receiving electric wave of the received broadcasts (Step S709). The control unit 290 judges whether the electric field intensity is no less than the prescribed value of electric field intensity (Step S711). When the electric field intensity is no less than the prescribed value of electric field intensity, the control unit 290 has the audio unit 220 output the broadcast as audio from the speaker 222 (Step S713). When receiving an operation from the operation unit 280, the control unit 290 stops outputting the broadcast, and ends the processing (Step S714). When the electric field intensity is less than the prescribed value of electric field intensity, the control unit 290 judges whether a frequency having an undetected electric field intensity is in the broadcast station information (Step S715). When the frequency having the undetected electric field intensity is in the broadcast station information, the broadcast receiving unit 230 receives a broadcast that has not been received in the broadcast station information (Step S719), and proceeds to Step S709. When there is no frequency having an undetected electric field intensity in the broadcast station information, the control unit 290 judges that no broadcast is receivable, and has the audio unit 220 output the built-in alarm sound from the speaker 222 (Step S717). When receiving an operation from the operation unit 280, the control unit 290 stops outputting the built-in alarm sound, and ends the processing (Step S718).

<Supplemental Description>

While the mobile phone according to the present invention has been described in accordance with the above-described embodiment, the present invention is not limited to the embodiment. The following will describe modification examples.

In the above embodiment, a zone is divided into rectangles. However, the zone may be divided into pieces with other shapes such as circles.

Also, in the above embodiment, the mobile phone 101 acquires its position information from the position calculation server 106. However, a CPU of the mobile phone 101 may calculate the position information.

Furthermore, in the above embodiment, when the mobile phone 101 cannot receive electric waves from no less than three GPS satellites of the GPS satellite group 103, a broadcast is switched to a built-in alarm sound. However, when sufficient electric waves cannot be received from the GPS satellites, electric waves transmitted from a base station may be used as supplement.

Furthermore, in the above embodiment, the mobile phone 101 starts receiving a broadcast at an alarm set time. However, the following may be employed. In Step S607, the control unit 290 judges whether a time outputted from the clock unit 260 is before an alarm set time by a predetermined time period, for example by one minute. The control unit 290 completes each operation in Steps S609 to S613, S617 to S711, and S715 to S719 before the alarm set time comes. And then, before the operation in Step S615, S713, or S717, the control unit 290 confirms whether the time outputted from the clock unit 260 matches the alarm set time. With this kind of embodiment, the mobile phone 101 can output a broadcast exactly at an alarm set time. Also, when a broadcast cannot be received, the mobile phone 101 can play a built-in alarm sound, instead of the broadcast.

Also, in the above embodiment, the mobile phone 101 receives broadcasts from broadcast stations in the broadcast station information in an ascending order of frequencies. When a broadcast having a receiving electric wave having an electric field intensity of no less than the prescribed value of electric field intensity is detected, the control unit 290 ends searching broadcast stations, and the audio unit 220 outputs the broadcast as audio from the speaker 222. However, the following may be employed. The control unit 290 has the broadcast receiving unit 230 receive all frequencies of a plurality of broadcast stations corresponding to a zone, has the detection unit 250 detect each electric field intensity of the received frequencies, and has the storage unit 270 store the detected electric field intensity. The control unit 290 has the audio unit 220 output as audio a broadcast of a frequency having a highest one among the stored electric field intensities, from the speaker 222.

Also, in the above embodiment, each time a broadcast of a set broadcast station cannot be received, the control unit 290 searches a position of the mobile phone 101. However, last position search information may be stored as a history in the RAM, and a zone may be determined based on the information.

Furthermore, in the above embodiment, the GPS is used in order to acquire the position information of the mobile phone 101. However, the mobile phone 101 may acquire an identifier of the base station or area information of an area to which the base station belongs by communicating with the base station, and determine a zone based on the acquired identifier or area information. In this case, an identifier group of the base station or the area information of the base station are written in the zone correspondence broadcast station information table 300 shown in the above embodiment, instead of longitude and latitude values of two points.

Also, in the above embodiment, a broadcast is described as a radio broadcast. However, instead of the radio broadcast, the mobile phone 101 may receive a television broadcast. When receiving a television broadcast, the display unit 240 may display an image, the speaker 222 may output audio, and brightness of the image and the audio may be used as an alarm. This kind of television broadcasts may be a digital television broadcast.

### Industrial Applicability

A mobile phone according to the present invention is used in the mobile communication fields as a mobile phone that achieves an alarm function by outputting broadcasts.

1. A mobile communication terminal having an alarm function, comprising:
a receiving unit operable to receive a broadcast;
a position information acquisition unit operable to acquire position information of the mobile communication terminal;
a storage unit operable to store a plurality of pieces of broadcast station information that correspond to zones;
a determination unit operable to determine a zone to which the position information belongs;
a detection unit operable to detect a receiving intensity of the broadcast received by the receiving unit;
a control unit operable to (a) cause the receiving unit to start receiving a preset broadcast at a predetermined time before an alarm set time, (b) cause the position information acquisition unit, when a receiving intensity of the preset broadcast detected by the detection unit is less than a prescribed value, to newly acquire position information, (c) read a piece of the broadcast station information that corresponds to a zone determined by the determination unit based on the newly acquired position information, (d) cause the receiving unit to receive a broadcast identified by the piece of the broadcast station information, and (e) select a broadcast having a receiving intensity of no less than the prescribed value; and
an output unit operable to output the selected broadcast at the alarm set time.

2. The mobile communication terminal of claim 1, wherein
the control unit causes the receiving unit to receive the broadcast having a highest receiving intensity detected by the detection unit among the broadcasts identified by the piece of the broadcast station information.

3. The mobile communication terminal of claim 1, wherein
the position information acquisition unit acquires the position information of the mobile communication terminal using a GPS.

4. The mobile communication terminal of claim 1, wherein
the position information acquisition unit acquires position information of a base station by communicating with the base station, and defines the position information as the position information of the mobile communication terminal.

5. The mobile communication terminal of claim 1, wherein
the broadcast station information corresponds to one or more zones.

6. The mobile communication terminal of claim 1, wherein
the detection unit detects an electric field intensity of a receiving electric wave of the broadcast received by the receiving unit, and
the prescribed value is a value of an electric field intensity indicates that the broadcast is clearly receivable.

7. The mobile communication terminal of claim 1, wherein
the control unit, when the broadcast having the receiving intensity of no less than the prescribed value is not found, causes the output unit to output a built-in alarm sound.

8. (canceled)

9. An alarm output method in a mobile communication terminal having an alarm function, comprising the steps of:
receiving a preset broadcast;
detecting an electric field intensity of a receiving electric wave of the received preset broadcast;
judging whether the electric field intensity detected in the electric field intensity detecting step is no less than a prescribed value, at a predetermined time before an alarm set time;
acquiring, when the electric field intensity is judged to be less than the prescribed value in the electric field intensity judging step, position information of the mobile communication terminal;
determining, based on the position information acquired in the position information acquiring step, a zone to which the position information belongs;
reading, based on the zone determined in the zone determining step, a piece of broadcast station information that corresponds to the zone;
selecting, by sequentially receiving a broadcast included in the broadcast station information read in the broadcast station information reading step, a broadcast of a receiving electric wave having an electric field intensity judged to be no less than the prescribed value in the electric field intensity judging step; and
outputting the broadcast selected in the broadcast selecting step, at the alarm set time.

10. An alarm output program that shows a processing procedure for causing a computer of a mobile communication terminal to output an alarm, the processing procedure comprising the steps of:
receiving a preset broadcast;
detecting an electric field intensity of a receiving electric wave of the received preset broadcast;
judging whether the electric field intensity detected in the electric field intensity detecting step is no less than a prescribed value, at a predetermined time before an alarm set time;
acquiring, when the electric field intensity is judged to be less than the prescribed value in the electric field intensity judging step, position information of the mobile communication terminal;
determining, based on the position information acquired in the position information acquiring step, a zone to which the position information belongs;
reading, based on the zone determined in the zone determining step, a piece of broadcast station information that corresponds to the zone;
selecting, by sequentially receiving a broadcast included in the broadcast station information read in the broadcast station information reading step, a broadcast of a receiving electric wave having an electric field intensity judged to be no less than the prescribed value in the electric field intensity judging step; and
outputting the broadcast selected in the broadcast selecting step, at the alarm set time.
